(19) United States
(12) Patent Application Publication
(10) Pub. No.: US 2009/0323309 A1
(43) Pub. Date: Dec. 31, 2009

(54) Optical plate and backlight module using the same

(75) Inventor: Shao-Han Chang, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: Hon Hai Precision Industry Co., LTD

(21) Appl. No.: 12/319,010

(22) Filed: Dec. 31, 2008

(30) Foreign Application Priority Data
Jun. 30, 2008 (CN) 200810302416.3

(51) Int. Cl. G09F 13/08; G02B 5/04

(52) U.S. Cl. 362/97.1; 359/831

(57) ABSTRACT

An optical plate includes a first surface, a second surface opposite to the first surface, a plurality of substantially parallel arc-shaped depressions defined in the first surface and a plurality of elongated arc-shaped protrusions and elongated V-shaped protrusions protruding out from the second surface. The elongated arc-shaped protrusions and the elongated V-shaped protrusions are substantially parallel to the arc-shaped depressions and arranged in an alternating manner. A backlight module using the optical plate is also provided.

### CROSS-REFERENCE TO RELATED APPLICATIONS

This application is related to five co-pending U.S. patent applications, which are: and applications serial no. [to be determined], with Attorney Docket No. US21576, US21577, US21604, US21678, US21686, and all entitled “OPTICAL PLATE AND BACKLIGHT MODULE USING THE SAME”. In the co-pending applications, the inventor is Shao-Han Chang. The co-pending applications have the same assignee as the present application. The disclosure of the above identified applications is incorporated herein by reference.

### BACKGROUND

1. Field of the Invention

The present invention relates to an optical plate and a backlight module using the same and, particularly, to an optical plate and a backlight module using the same employed in a liquid crystal display.

2. Description of the Related Art

Referring to FIGS. 7 and 8, a typical direct type backlight module 100 includes a frame 11, a plurality of light sources 12, a light diffusion plate 13, and a typical prism sheet 10. The light sources 12 are positioned in an inner side of the frame 11. The light diffusion plate 13 and the prism sheet 10 are positioned on the light sources 12 above a top of the frame 11. The light diffusion plate 13 includes a plurality of diffusing particles (not shown) configured for diffusing light. The prism sheet 10 includes a transparent substrate 101 and a prism layer 103 formed on a surface of the transparent substrate 101. A plurality of elongated V-shaped ridges 105 is formed on the prism layer 103.

In use, light emitted from the light sources 12 enters the diffusion plate 13 and becomes scattered. The scattered light leaves the diffusion plate 13, travels through the typical prism sheet 10, and is refracted out at the elongated V-shaped ridges 105. The refracted light leaving the typical prism sheet 10 is concentrated at the prism layer 103 and increases the brightness of the typical prism sheet 10. The refracted light propagates into a liquid crystal display panel (not shown) positioned above the typical prism sheet 10. However, although light from the light sources 12 enters the diffusion plate 13 and becomes scattered, the light leaves the typical prism sheet 10, and forms strong light spots.

In order to reduce or eliminate the strong light spots, the backlight module 100 further includes an upper light diffusion film 14 positioned on the typical prism sheet 10. However, although the upper light diffusion film 14 and the typical prism sheet 10 are contacting each other, a plurality of air pockets exist around the boundaries of the light diffusion film 14 and the typical prism sheet 10. When light passes through the air pockets, some of the light undergoes total reflection along one or more corresponding boundaries. In addition, the upper light diffusion film 14 may absorb a certain amount of the light from the typical prism sheet 10. As a result, a brightness of light illumination of the backlight module 100 is reduced.

Therefore, a new optical plate and a new backlight module are desired to overcome the above-described shortcomings.

### BRIEF DESCRIPTION OF THE DRAWINGS

The components in the drawings are not necessarily drawn to scale, the emphasis instead being placed upon clearly illustrating the principles of the present disclosure. Moreover, in the drawings, like reference numerals designate corresponding parts throughout several views, and all the views are schematic.

FIG. 1 is a side cross-sectional view of an embodiment of a backlight module, the backlight module including a first embodiment of an optical plate of FIG. 1.

FIG. 2 is an isometric view of the optical plate of FIG. 1.

FIG. 3 is an enlarged, side cross-sectional view of the optical plate of FIG. 2, taken along line III-III.

FIG. 4 is a photo showing an illumination distribution test result of the backlight module of FIG. 1.

FIG. 5 is a side cross-sectional view of a second embodiment of an optical plate.

FIG. 6 is a side cross-sectional view of a third embodiment of an optical plate.

FIG. 7 is a side cross-sectional view of a typical backlight module including a typical prism sheet and an upper light diffusion film.

FIG. 8 is an isometric view of the typical prism sheet of the typical backlight module of FIG. 7.

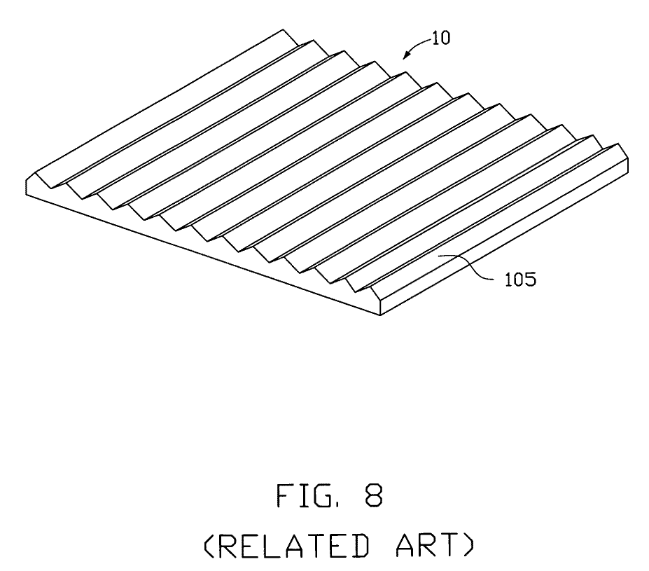

FIG. 9 is a photo showing an illumination distribution test result of the typical backlight module of FIG. 7 without the typical prism sheet and the upper light diffusion film.

FIG. 10 is a photo showing an illumination distribution test result of the typical backlight module of FIG. 7, the typical backlight module including the typical prism sheet.

### DETAILED DESCRIPTION

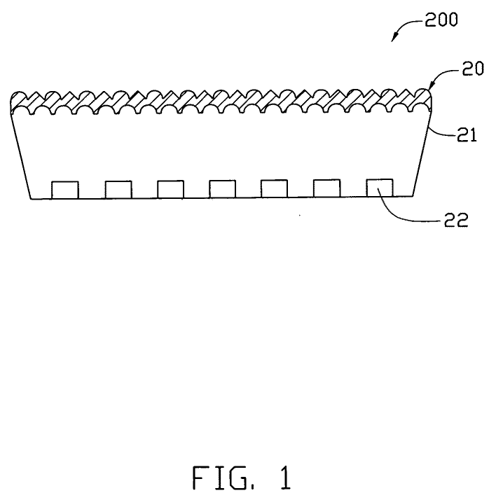

Referring to FIG. 1, one embodiment of a backlight module 200 includes a first embodiment of an optical plate 20, a frame 21, and a plurality of point light sources 22. The point light sources 22 are positioned in an inner side of the frame 21. The optical plate 20 is positioned on a top of the frame 21 above the linear light sources 22. The frame 21 has a highly reflective inner surface. In the illustrated embodiment, the point light sources 22 are light emitting diodes. In an alternative embodiment, the backlight module 200 may use linear light sources, such as cold cathode fluorescent lamps.

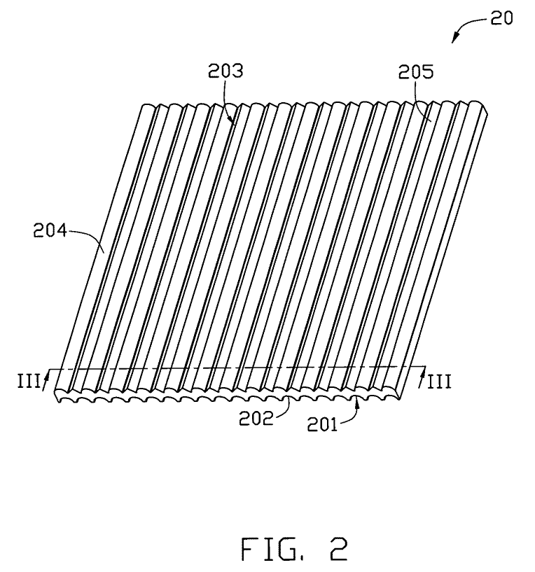

Referring to FIG. 2, the optical plate 20 has a first surface 201 and a second surface 203 opposite to the first surface 201. The first surface 201 faces the linear light sources 22 and the second surface 203 faces away from the point light sources 22. The optical plate 20 further includes a plurality of elongated arc-shaped protrusions 204 and a plurality of V-shaped protrusions 205 protruding out from the second surface 203. The elongated arc-shaped protrusions 204 and the elongated V-shaped protrusions 205 are substantially parallel to each other and arranged side by side in an alternating manner. The optical plate 20 further includes a plurality of elongated arc-shaped depressions 202 defined in the first surface 201. An extending direction of each elongated arc-shaped depression 202 is substantially parallel to an extending direction of the elongated arc-shaped protrusions 204 and the elongated V-shaped protrusions 205.

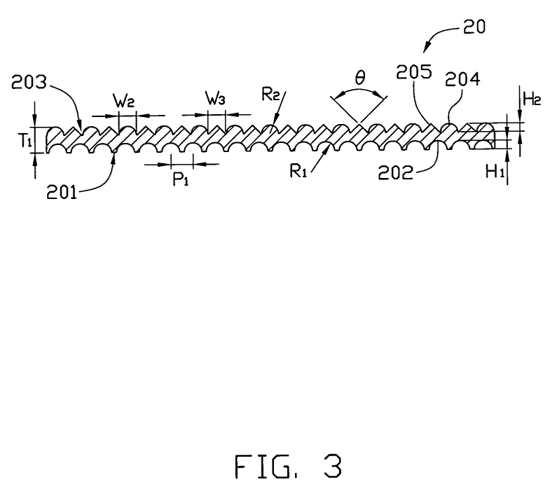

Referring to FIG. 3, in the illustrated embodiment, a cross-section of each arc-shaped depression 202 taken along a plane perpendicular to the extending direction of the elongated arc-shaped depressions 202 is substantially semicircular. A radius R₁ of each elongated arc-shaped depression 202 is about 0.006 millimeters (mm) to about 2 mm. A pitch P₁ of adjacent elongated arc-shaped depressions 202 is about 0.025 mm to about 1 mm. A depth H₁ of each elongated arc-shaped depression 202 is about 0.01 mm to about 2 mm. In the illustrated embodiment, the radius R₁ of each elongated arc-shaped depression 202 is about 0.14 mm.

Referring to FIG. 3 again, in the illustrated embodiment, a cross-section of each arc-shaped protrusion 204 taken along a plane perpendicular to the extending direction of the elongated arc-shaped protrusions 204 is substantially semicircular. A radius R₂ of each elongated arc-shaped protrusion 204 is about 0.006 millimeters to about 3 millimeters. A maximum width W₂ of elongated arc-shaped protrusions 204 is about 0.025 millimeters to about 1.5 millimeters. A height H₂ of each elongated arc-shaped protrusion 204 is about 0.01 millimeters to about 3 millimeters. In the illustrated embodiment, the radius R₂ of each elongated arc-shaped protrusion 204 is about 0.1375 millimeters, the maximum width W₂ is about 0.275 millimeters and the height H₂ is about 0.1375 millimeters.

A cross-section of each V-shaped protrusion 205 taken along a plane perpendicular to an extending direction of the elongated V-shaped protrusions 205 is substantially triangular. A maximum width W₂ of elongated V-shaped protrusions 205 is about 0.025 millimeters to about 1 millimeter. A vertex angle θ of each elongated V-shaped protrusion 205 is about 80 degrees to about 100 degrees. In the illustrated embodiment, the maximum width W₂ is about 0.275 millimeters. The vertex angle θ is about 90 degrees.

A combined thickness T₁ of the optical plate 20 is about 0.4 millimeters to about 4 millimeters. The optical plate 20 may be made of a transparent material such as polycarbonate, polymethyl methacrylate, polystyrene, and copolymer of methyl methacrylate and styrene.

Referring to the Table 1 below, test samples are provided to get an optical performance of the optical plate 20 in contrast to that of the optical plate 10.

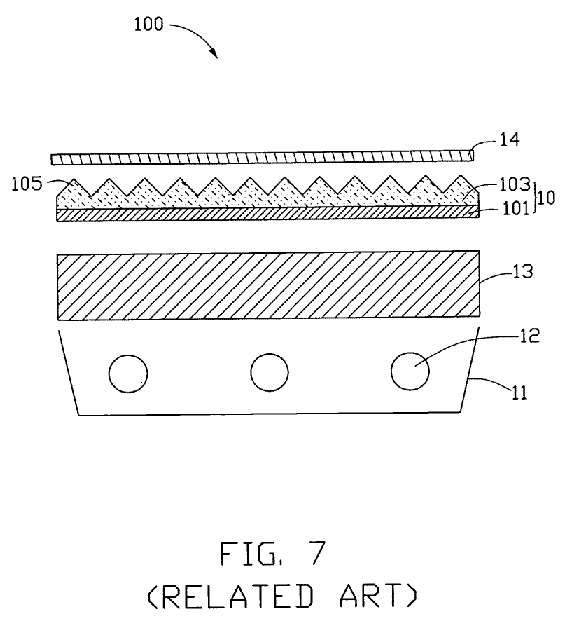

TABLE 1

| Test | |
|---|---|
| samples | Condition |
| 1 | Backlight module of FIG. 7 without the typical prism sheet 10 |
| | and the upper light diffusion film 14 |
| 2 | Backlight module of FIG. 7 including the typical prism sheet 10 |
| 3 | Backlight module of FIG. 1 including the optical plate 20 |

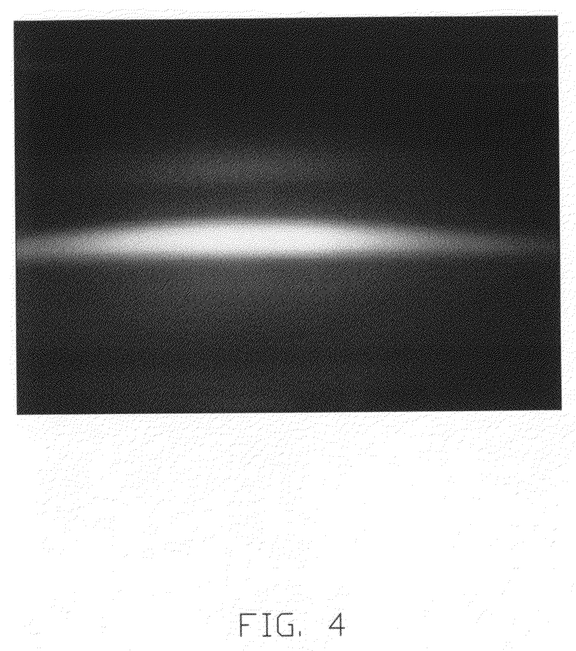

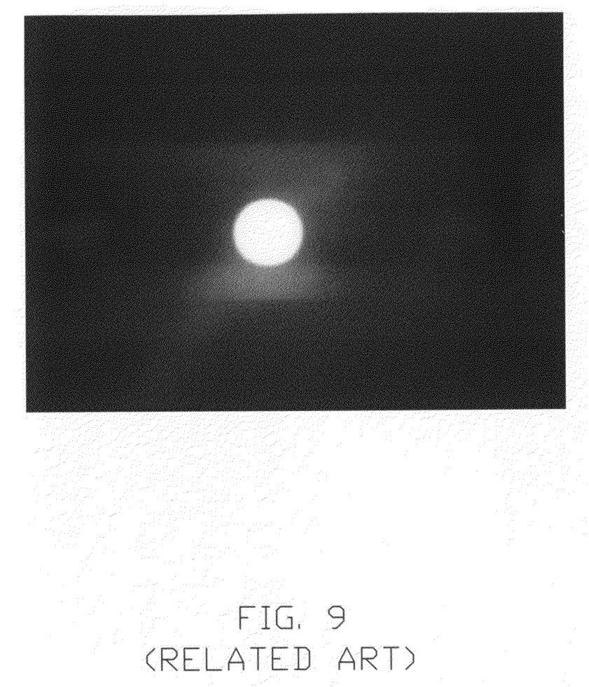

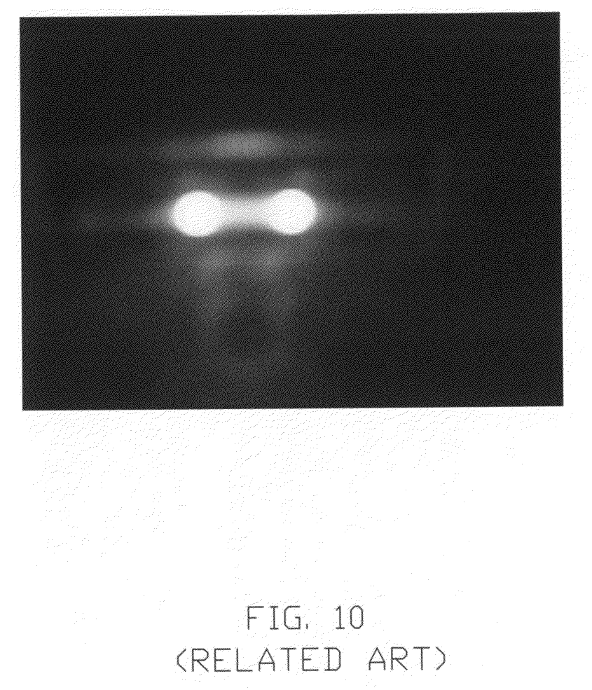

Referring to the FIGS. 4, 9 and 10, which reflect the test results from the test conditions described in Table 1. Light emitted from the typical prism sheet 10 forms two relatively strong light spots as shown in FIG. 10. In contrast, light emitted from the optical plate 20 forms a substantially rectangular, relatively weak light region as shown in FIG. 4. The test results show light emitted from the optical plate 20 can translate a spot light, such as an LED, to a surface light source. The light from the optical plate 20 is more uniform.

Light emitted from the point light sources 22 enters the first surface 201 of the optical plate 20. Since the elongated arc-shaped depressions 202 has curved surfaces and the elongated arc-shaped protrusions 204 and the elongated V-shaped protrusions 205 are arranged in an alternating manner to form a complex curved surface, incident light that may have been internally reflected on a flat surface, are refracted, reflected, and diffracted. As a result, light outputted from the second surface 203 is more optically uniform than light outputted from a light output surface of a typical prism sheet. Light spots caused by the point light sources seldom occur. In addition, an extra upper light diffusion film above the optical plate 20 in the backlight module 200 is unnecessary. Thus, the efficiency of light utilization is enhanced.

In addition, the optical plate 20 can be integrally formed by injection molding. Since the optical plate 20 is integrally formed by the injection mold, the optical plate 20 has a better rigidity and mechanical strength than the typical prism sheet. Thus, the optical plate 20 has a relatively high reliability.

It may be appreciated that if a distance between the optical plate 20 and the point light sources 22 is relatively large, the backlight module 200 may further include a light diffusion plate positioned between the optical plate 20 and the point light sources 22.

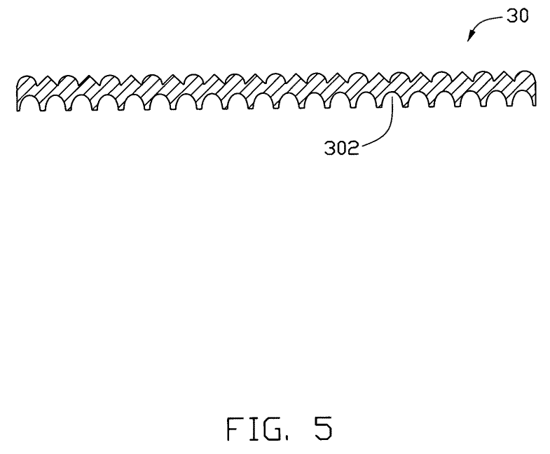

Referring to FIG. 5, a second embodiment of an optical plate 30 is similar in principle to the optical plate 20 of the first embodiment, except that a cross-section of each arc-shaped depression 302 taken along a plane perpendicular to an extending direction of the elongated arc-shaped depressions 302 is substantially semi-elliptical.

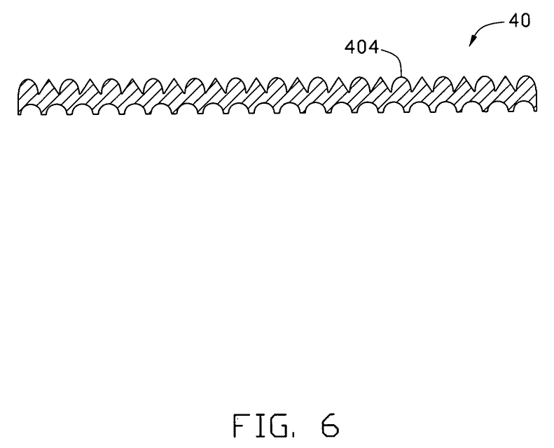

Referring to FIG. 6, a third embodiment of an optical plate 40 is similar in principle to the optical plate 20 of the first embodiment, except that a cross-section of each arc-shaped protrusion 404 taken along a plane perpendicular to an extending direction of the elongated arc-shaped protrusions 404 is substantially semi-elliptical.

Finally, while the embodiments have been described and illustrated, the present disclosure is not to be construed as being limited thereto. Various modifications can be made to the embodiments by those of ordinary skilled in the art without departing from the true spirit and scope of the embodiments as defined by the appended claims.

What is claimed is:

1. An optical plate, comprising:
a first surface;
a second surface opposite to the first surface;
a plurality of substantially parallel arc-shaped depressions defined in the first surface; and
a plurality of elongated arc-shaped protrusions and elongated V-shaped protrusions protruding from the second surface, wherein the elongated arc-shaped protrusions and the elongated V-shaped protrusions are substantially parallel to the arc-shaped protrusions and arranged in an alternating manner.

2. The optical plate of claim 1, wherein a cross-section of each elongated arc-shaped protrusion taken along a plane perpendicular to the extending direction of the elongated arc-shaped protrusion is substantially semicircular or semi-elliptical.

3. The optical plate of claim 1, wherein a cross-section of each elongated V-shaped protrusion taken along a plane perpendicular to the extending direction of the elongated V-shaped protrusion is substantially triangular.

4. The optical plate of claim 1, wherein a width of each elongated arc-shaped protrusion is about 0.025 millimeters to about 1.5 millimeters.

5. The optical plate of claim 1, wherein a height of each elongated arc-shaped protrusion is about 0.01 millimeters to about 3 millimeters.

6. The optical plate of claim 1, wherein a width of each elongated V-shaped protrusion is about 0.025 millimeters to about 1 millimeter.

7. The optical plate of claim 1, wherein a cross-section of each elongated arc-shaped depressions taken along a plane perpendicular to the extending direction of the elongated arc-shaped depression is substantially semicircular or semi-elliptical.

8. The optical plate of claim 1, wherein the combined thickness of the optical plate is about 0.4 millimeters to about 4 millimeters.

9. The optical plate of claim 1, wherein a material of the optical plate is selected from the group consisting of polycarbonate, polymethyl methacrylate, polystyrene, and copolymer of methylmethacrylate and styrene.

10. The optical plate of claim 1, wherein a pitch of adjacent elongated arc-shaped depressions is about 0.025 millimeters to about 1 millimeter.

11. The optical plate of claim 1, wherein a depth of each elongated arc-shaped depression is about 0.01 millimeters to about 2 millimeters.

12. A backlight module, comprising:
a frame;
a plurality of light sources positioned in an inner surface of the frame; and
an optical plate positioned above the light sources, the optical plate comprising a first surface facing the light sources, a second surface opposite to the first surface, a 20 plurality of substantially parallel arc-shaped depressions defined in the first surface, and a plurality of elongated arc-shaped protrusions and elongated V-shaped protrusions protruding from the second surface, wherein the elongated arc-shaped protrusions and the elongated V-shaped protrusions are substantially parallel to the arc-shaped depressions and arranged in an alternative manner.

13. The backlight module of claim 12, wherein the light sources are linear light sources or point light sources.

14. The backlight module of claim 12, further comprising a light diffusion plate positioned between the optical plate and the light sources.

15. The backlight module of claim 12, wherein the frame has a highly reflective inner surface.

16. The backlight module of claim 12, wherein a cross-section of each elongated arc-shaped protrusion taken along a plane perpendicular to the extending direction of the elongated arc-shaped protrusion is substantially semicircular or semi-elliptical.

17. The backlight module of claim 12, wherein a cross-section of each elongated V-shaped protrusion taken along a plane perpendicular to the extending direction of the elongated V-shaped protrusion is substantially triangular.

18. The backlight module of claim 12, wherein a width of each elongated arc-shaped protrusion is about 0.025 millimeters to about 1.5 millimeters.

19. The backlight module of claim 12, wherein a height of each elongated arc-shaped protrusion is from about 0.01 millimeters to about 3 millimeters.

20. The backlight module of claim 12, wherein a width of each elongated V-shaped protrusion is about 0.025 millimeters to about 1 millimeter.
